(19) United States
(12) Patent Application Publication
(10) Pub. No.: US 2005/0111427 A1
(43) Pub. Date: May 26, 2005

(54) SDMA training and operation

(76) Inventors: Qinghua Li, Sunnyvale, CA (US); Minnie Ho, Los Altos, CA (US); Adrian P. Stephens, Cottenham (GB); Xintian E. Lin, Palo Alto, CA (US)

Correspondence Address: Blakely, Sokoloff, Taylor & Zafman LLP, Suite 101, 5285 S.W. Meadows Road, Lake Oswego, OR, 97035, US

(21) Appl. No.: 10/719,470

(22) Filed: Nov. 21, 2003

(51) Int. Cl. H04J 1/00

(52) U.S. Cl. 370/343

(57) ABSTRACT

A network comprising a base station and multiple mobile devices may use a training phase for the base station to develop parameters that enable spatial division multiple access (SDMA) techniques to be used for communications with the mobile devices, and to subsequently use those parameters in a data phase, thus permitting substantially simultaneous transmissions to, and substantially simultaneous receptions from, the multiple mobile devices on the same frequency.

### BACKGROUND

To address the problem of ever-increasing bandwidth requirements that are placed on wireless data communications systems, various techniques are being developed to allow multiple devices to communicate with a single base station by sharing a single channel. In one such technique, a base station may transmit or receive separate signals to or from multiple mobile devices at the same time on the same frequency, provided the mobile devices are located in sufficiently different directions from the base station. For transmission from the base station, different signals may be simultaneously transmitted from each of separate spaced-apart antennas so that the combined transmissions are directional, i.e., the signal intended for each mobile device may be relatively strong in the direction of that mobile device and relatively weak in other directions. In a similar manner, the base station may receive the combined signals from multiple independent mobile devices at the same time on the same frequency through each of separate spaced-apart antennas, and separate the combined received signals from the multiple antennas into the separate signals from each mobile device through appropriate signal processing so that the reception is directional.

Under currently developing specifications, such as IEEE 802.11 (IEEE is the acronym for the Institute of Electrical and Electronic Engineers, 3 Park Avenue, 17th floor, New York, N.Y.), the parameters needed to control the directional nature of both transmissions and receptions may vary depending on various factors, including the direction of each mobile device from the base station. Since these factors may not be known in advance of operation, and may even change during operation, they may not be programmed into the system in advance.

### BRIEF DESCRIPTION OF THE DRAWINGS

The invention may be understood by referring to the following description and accompanying drawings that are used to illustrate embodiments of the invention. In the drawings:

FIG. 1 shows a diagram of a communications network for both training and operation, according to an embodiment of the invention.

FIG. 2 shows a flow chart of an operation that comprises determining parameters and using those parameters in communications, according to an embodiment of the invention.

FIG. 3 shows a timing diagram of an example of an operation such as that described in FIG. 2, according to an embodiment of the invention.

FIG. 4 shows a block diagram of a base station, according to an embodiment of the invention.

### DETAILED DESCRIPTION OF THE INVENTION

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,”or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

In keeping with common industry terminology, the terms “base station”, “access point”, and “AP” may be used interchangeably herein to describe an electronic device that may communicate wirelessly and substantially simultaneously with multiple other electronic devices, while the terms “mobile device” and “STA” may be used interchangeably to describe any of those multiple other electronic devices, which may have the capability to be moved and still communicate, though movement is not a requirement. However, the scope of the invention is not limited to devices that are labeled with those terms. Similarly, the terms “spatial division multiple access” and SDMA may be used interchangeably. As used herein, these terms are intended to encompass any communication technique in which different signals may be transmitted by different antennas substantially simultaneously from the same device such that the combined transmitted signals result in different signals intended for different devices being transmitted substantially in different directions on the same frequency, and/or techniques in which different signals may be received substantially simultaneously through multiple antennas on the same frequency from different devices in different directions and the different signals may be separated from each other through suitable processing. The term “same frequency”, as used herein, may include slight variations in the exact frequency due to such things as bandwidth tolerance, Doppler shift adaptations, parameter drift, etc. Two or more transmissions to different devices are considered substantially simultaneous if at least a portion of each transmission to the different devices occurs at the same time, but does not imply that the different transmissions must start and/or end at the same time, although they may. Similarly, two or more receptions from different devices are considered substantially simultaneous if at least a portion of each reception from the different devices occurs at the same time, but does not imply that the different transmissions must start and/or end at the same time, although they may. Variations of the words represented by the term SDMA may sometimes be used by others, such as but not limited to substituting “space” for “spatial”, or “diversity” for “division”. The scope of various embodiments of the invention is intended to encompass such differences in nomenclature.

Some embodiments of the invention may comprise a determination, during operation, of what parameters may be used to enable substantially simultaneous transmissions and/or substantially simultaneous receptions using SDMA techniques, and the use of those parameters in SDMA communications.

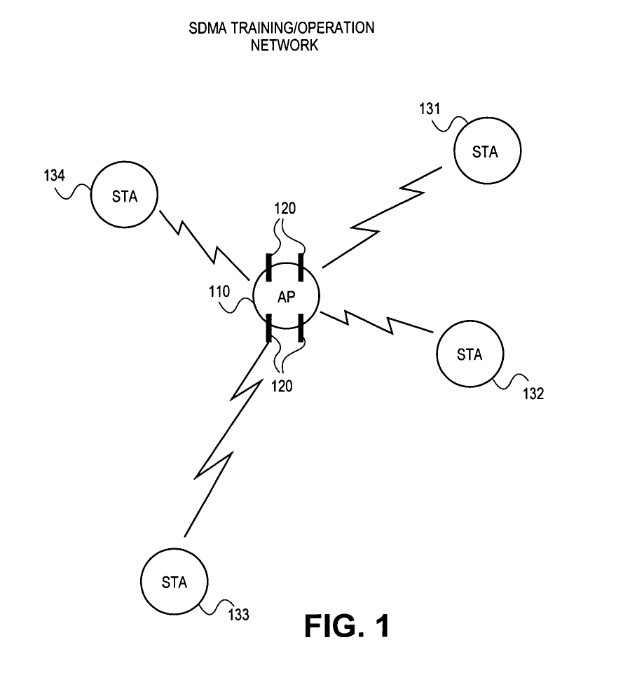

FIG. 1 shows a diagram of an SDMA communications network for both SDMA training and SDMA operation, according to an embodiment of the invention. The illustrated embodiment of a communications network shows an AP 110 that may communicate with multiple STAs 131-134 located in different directions from the AP. Using the techniques described herein, the AP 110 may employ an SDMA training phase to determine the parameters needed to transmit different signals to each of multiple ones of the STAs substantially simultaneously on the same frequency, and to receive different signals from each of multiple ones of the STAs substantially simultaneously on the same frequency, and may then use those parameters to enable such substantially simultaneous communications.

Although AP 110 is shown with four antennas 120 to communicate wirelessly with up to four STAs at a time using SDMA techniques, other embodiments may have other arrangements (e.g., AP 110 may have two, three, or more than four antennas). Each STA may have at least one antenna to communicate wirelessly with the AP 110. In some embodiments the STA antenna(s) may be adapted to operate omnidirectionally, but in other embodiments the STA antenna(s) may be adapted to operate directionally. In some embodiments the STAs may be in fixed locations, but in other embodiments at least some of the STAs may be mobile. In some embodiments the AP 110 may be in a fixed location, but in other embodiments the AP 110 may be mobile.

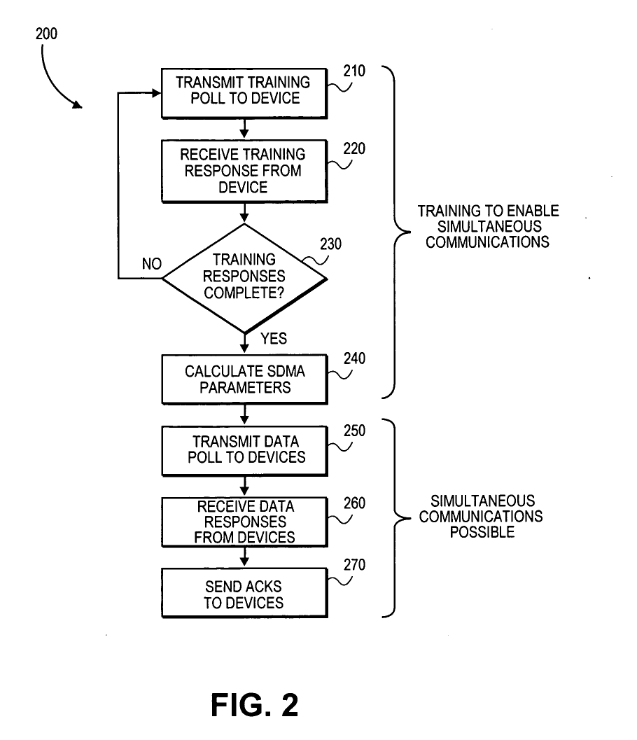

FIG. 2 shows a flow chart of an operation that comprises determining SDMA parameters and using those parameters in communications, according to an embodiment of the invention. Flow chart 200 includes two sections: blocks 210, 220, 230 and 240 indicate a training process which may be used to determine the parameters to enable substantially simultaneous directional communications operations to take place. Blocks 250, 260 and 270 indicate a process in which those parameters may be used to enable substantially simultaneous directional communications with multiple devices that are located in different directions from the device performing these operations.

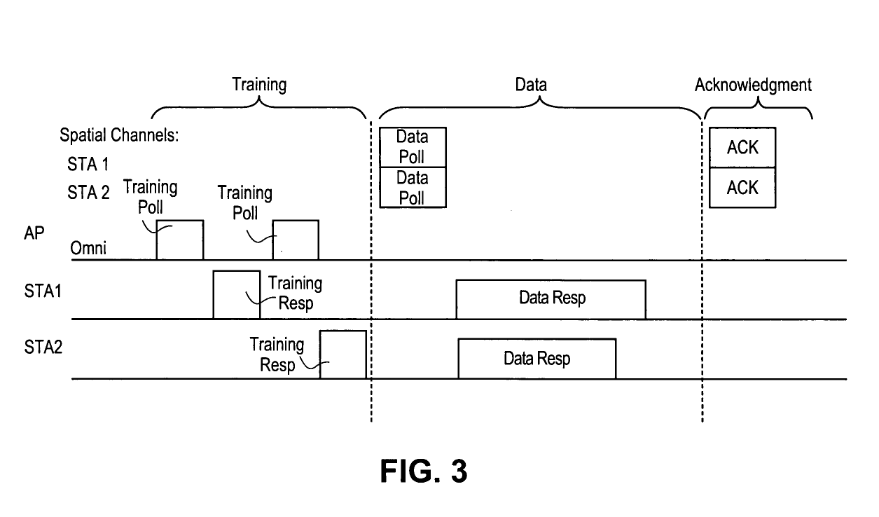

FIG. 3 shows a timing diagram of an example of an operation such as that described in FIG. 2, according to an embodiment of the invention. In FIG. 3, transmissions from a base station are on the line indicated as AP, while transmissions from two mobile devices are on the lines indicated as STA1 and STA2, respectively. The AP line is further sub-divided into spatial channels, labeled as STA 1 (directional transmissions from the base station to the mobile device ST1), STA 2 (directional transmissions from the base station to the mobile device STA2), and Omni (omnidirectional transmissions from the base station which may be received by both ST1 and ST2). The following description refers primarily to FIG. 2, with references to FIG. 3.

FIG. 2 shows a sequential training loop 210, 220, 230. At 210 the base station may transmit a training poll to a mobile device to cause that mobile device to send a training response to the base station at 220. A training response may comprise a predetermined data pattern, so that the base station has a known baseline with which to work. This sequence may then be repeated for each mobile device in turn as shown at 230 and as illustrated in FIG. 3. By polling each mobile device separately, each training response may be received at a different time so that responses from different mobile devices will not interfere with each other at the receiver of the base station during the training phase. During the training phase the base station may not yet have the capability to send directional signals, so the training polls may be broadcast in an omnidirectional manner as indicated in FIG. 3, with an address specifying which mobile device is the intended recipient. The addressed mobile device may then respond with a training response. The training response may be received by the base station at each of multiple antennas, and the signals received at the multiple antennas then processed. Processed data from the processed signals may be stored for future use. Although in some embodiments a training response is used only for SDMA training purposes, other embodiments may include information in the training response that is not related to SDMA training, and that may be used for other purposes.

At 240 the SDMA parameters may be calculated, based on the stored data from the previously processed signals, although the scope of the invention is not limited to this two stage signal-processing/parameter-calculation sequence. Once the SDMA parameters are calculated, the base station may transmit different signals substantially simultaneously in different directions by using the SDMA parameters to pre-process individual signals and sending different versions of the pre-processed signals to each antenna for simultaneous transmission. The resulting combination of transmitted signals from the multiple antennas may effectively produce directional beams to the various mobile devices. Similarly, once the SDMA parameters are calculated, the base station may receive different signals from different mobile devices substantially simultaneously through multiple antennas, and separate the combined received signals into the separate signals from the different devices through suitable processing with the SDMA parameters. The result may be the same as if directional beams had been received from each mobile device separately without substantial interference from the beams from the other mobile devices. Because the effective results of these techniques are similar to transmitting and/or receiving directional beams, the SDMA parameters may sometimes be referred to as beam-forming parameters, or beam-forming weights.

Once the capability for directional transmission and reception has been established, the base station may communicate with multiple mobile devices at the same time when the mobile devices are in different directions from the base station. At 250 the base station may transmit directional data polls substantially simultaneously to multiple ones of the mobile devices. In response to its respective data poll, a polled mobile device may transmit a data response to the base station at 260. In various embodiments, substantially simultaneous data polls may be sent to all or only some of the mobile devices for which the base station has SDMA parameters. Those mobile devices which were substantially simultaneously polled may then substantially simultaneously transmit data responses to the base station. Substantially simultaneous data polls and substantially simultaneous data responses are shown in the ‘Data” portion of FIG. 3.

At 270, the base station may transmit an acknowledgement (ACK) to each mobile device from which the base station has correctly received the data response. In some embodiments, the ACKs may be transmitted substantially simultaneously and directionally as shown in FIG. 3. In some embodiments, if any data response is not received, or if it is received with uncorrectable errors, the base station may withhold the acknowledgement to that particular mobile device.

FIGS. 2 and 3 indicate that substantially simultaneous communications may be possible for each of data polls, data responses, and acknowledgements. However, some embodiments may not require substantially simultaneous communications for one or more of these operations. Although substantially simultaneous communications may generally improve throughput as compared to sequential communications, other factors may make sequential communications preferable in one or more of these three operations.

The illustrated embodiments show a single training phase followed by a single data phase and a single acknowledgement phase. However, once the parameters have been established during the training phase, those parameters may be used for multiple data phases and/or acknowledgement phases as long as the parameters are deemed to be usable. New training phases may be implemented as often as necessary. The frequency with which new training phases are implemented may depend on various factors, e.g., how quickly mobile devices may move to a new direction from the base station, how directional the communications are, how often new mobile devices are introduced, etc.

Various embodiments of the invention may be implemented in one or a combination of hardware, firmware, and software. Embodiments of the invention may also be implemented as instructions stored on a machine-readable medium, which may be read and executed by a computing platform to perform the operations described herein, for example those operations described in FIGS. 2 and 3 and the associated text. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

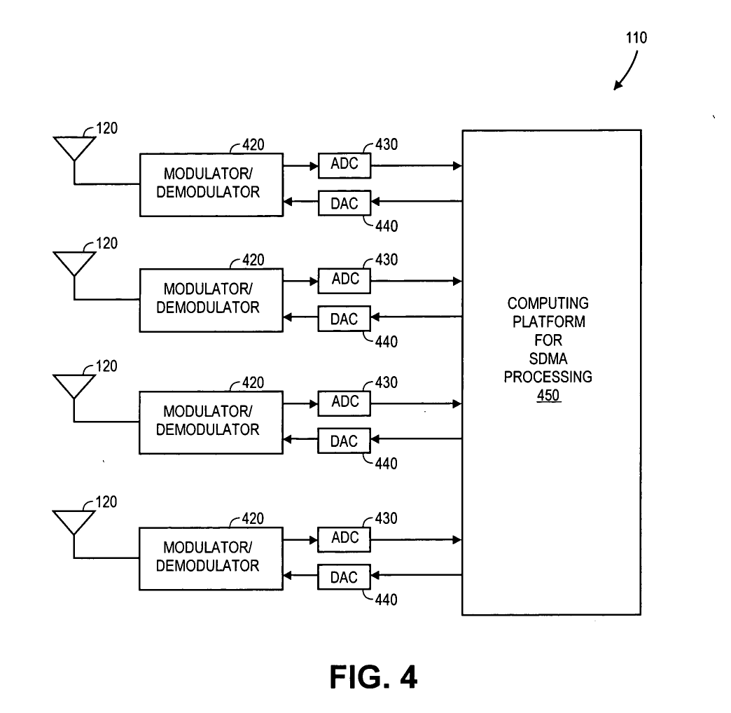

FIG. 4 shows a block diagram of a base station, according to an embodiment of the invention. Computing platform 450 may include one or more processors, and at least one of the one or more processors may be a digital signal processor (DSP). In the illustrated embodiment, AP 110 has four antennas 120, but other embodiments may have two, three, or more than four antennas. For each antenna, base station 110 may have a modulator/demodulator 420, an analog-to-digital converter (ADC) 430, and a digital-to-analog converter (DAC) 440. The combination of demodulator-ADC may convert received radio frequency signals from the antenna into digital signals suitable for processing by the computing platform 450. Similarly, the combination of DAC-modulator may convert digital signals from the computing platform 450 into radio frequency signals suitable for transmission through an antenna. Other components not shown may be included in the illustrated blocks as needed, such as but not limited to amplifiers, filters, oscillators, etc.

The foregoing description is intended to be illustrative and not limiting. Variations may occur to those of skill in the art. Those variations are intended to be included in the various embodiments of the invention, which are limited only by the spirit and scope of the appended claims.

1. An apparatus, comprising:
a first electronic device adapted to perform
a training phase with multiple second electronic devices to calculate parameters to enable substantially simultaneous spatial division multiple access transmissions to multiple ones of the multiple second electronic devices; and
a data phase by using the parameters to perform the spatial division multiple access transmissions.

2. The apparatus of claim 1, wherein the first electronic device is further adapted to perform an acknowledgement phase by using the parameters to perform substantially simultaneous spatial division multiple access transmissions of acknowledgements to the multiple ones of the second electronic devices subsequent to the data phase.

3. The apparatus of claim 1, wherein the first electronic device is further adapted to perform the data phase by:
transmitting substantially simultaneous data polls to the multiple ones of the multiple second electronic devices through multiple antennas; and
receiving substantially simultaneous data responses from the multiple ones of the multiple second electronic devices through multiple antennas.

4. The apparatus of claim 1, wherein the first electronic device is further adapted to perform the training phase by:
transmitting training polls to the multiple second electronic devices;
receiving training responses from the multiple second electronic. devices through multiple antennas;
processing the training responses received through the multiple antennas; and
calculating the parameters based on the processed training responses.

5. The apparatus of claim 1, wherein the parameters comprise beam forming parameters.

6. The apparatus of claim 1, wherein the parameters are further to enable substantially simultaneous spatial division multiple access receptions from the multiple ones of the multiple second electronic devices.

7. The apparatus of claim 1, wherein the first electronic device further comprises at least four antennas to communicate with the multiple second electronic devices during the training phase and the data phase.

8. The apparatus of claim 7, wherein the first electronic device further comprises a computing platform coupled to the at least four antennas.

9. The apparatus of claim 8, wherein the first electronic device further comprises at least four modulator/demodulators with at least one modulator/demodulator coupled between each of the at least four antennas and the computing platform.

10. The apparatus of claim 9, wherein the first electronic device further comprises multiple analog-to-digital converters and multiple digital-to-analog converters with at least one analog-to-digital converter and at least one digital-to-analog converter coupled between each modulator/demodulator and the computing platform.

11. A method, comprising:
transmitting a training poll to a first mobile device;
receiving a training response from the first mobile device;
transmitting a training poll to a second mobile device;
receiving a training response from the second mobile device;
calculating parameters based on the received training response from the first mobile device and the received training response from the second mobile device; and
using-the parameters to enable spatial division multiple access transmissions to the first and second mobile devices.

12. The method of claim 11, wherein said using comprises:
transmitting a first data poll to the first mobile device and a second data poll to the second mobile device substantially simultaneously using spatial division multiple access techniques; and
receiving a response to the first data poll from the first mobile device and a response to the second data poll from the second mobile device substantially simultaneously.

13. The method of claim 12, further comprising transmitting, subsequent to said receiving, an acknowledgement to the first mobile device and an acknowledgement to the second mobile device substantially simultaneously using the spatial division multiple access techniques.

14. The method of claim 13, wherein said calculating the parameters comprises calculating beam forming parameters.

15. The method of claim 13, wherein the parameters are further used to enable spatial division multiple access receptions from the first and second mobile devices.

16. A machine-readable medium that provides instructions, which when executed by a processing platform, cause said processing platform to perform operations comprising:
transmitting a training poll to a first device;
receiving a training response from the first device;
transmitting a training poll to a second device;
receiving a training response from the second device;
calculating parameters based on the received training response from the first device and the received training response from the second device; and
using the parameters to enable substantially simultaneous transmissions to the first and second devices using spatial division multiple access techniques.

17. The medium of claim 16, wherein said operations further comprise:
using the parameters to enable transmitting a data poll to the first device and a data poll to the second device substantially simultaneously using the spatial division multiple access techniques; and
using the parameters to enable receiving a data response from the first device and a data response from the second device substantially simultanebusly using the spatial division multiple access techniques.

18. The medium of claim 17, wherein said operations further comprise using the parameters to enable transmitting an acknowledgement to the first device and an acknowledgement to the second device substantially simultaneously using the spatial division multiple access techniques.

19. The medium of claim 16, further comprising using the parameters to enable substantially simultaneous receptions from the first and second devices using the spatial division multiple access techniques.
